(19) United States
(12) Patent Application Publication
(10) Pub. No.: US 2013/0119074 A1
(43) Pub. Date: May 16, 2013

(54) SYSTEM AND METHOD OF VACUATING ABOVE GROUND STORAGE TANKS

(71) Applicants: Yehezkel Samy Ezair, Haifa (IL); Daniel Berman, Tel Aviv (IL)

(72) Inventors: Yehezkel Samy Ezair, Haifa (IL); Daniel Berman, Tel Aviv (IL)

(21) Appl. No.: 13/812,512

(22) PCT Filed: Jul. 26, 2011
(86) PCT No.: PCT/IL2011/000599

§ 371 Date: Jan. 27, 2013

(30) Foreign Application Priority Data
Jul. 28, 2010 (IL) 207266

(51) Int. Cl. B65D 90/08

(52) U.S. Cl. CPC B65D 90/08
USPC 220/610; 29/426.1

(57) ABSTRACT

A system and method for cleaning an above ground storage tank, where the side walls of the tank are separable from a bottom of the tank. Verticals members may be attached to the side walls of the tank, and a lifting force may be applied to the vertical members by a series of jacks so that the side walls are raised above the bottom. The side wall may be suspended above the bottom while the tank is cleaned out, and then lowered again when the cleaning is complete.

### FIELD OF THE INVENTION

The invention relates to above ground storage tanks such as those used to store fuels and chemicals at industrial facilities.

### BACKGROUND OF THE INVENTION

Above ground storage tanks (AST) may store and contain fuels or other chemicals at industrial facilities such as airports, refineries, depots, factories etc. An AST may be filled and drawn down numerous times and over extended periods before it must be cleaned out from residues, sediment, sludge and other deposits that may accumulate at its bottom. The sometimes toxic nature of the sediment and the air in the drawn down AST may require special procedures and protections to be taken during the cleaning and vacuation of the residues. Further, the viscous nature of the sediment may make removal of the sediment difficult and time consuming.

### SUMMARY OF THE INVENTION

The present invention describes a method for vacuating residue from an above ground storage comprising: separating a side of said storage tank from a bottom of said storage tank; lifting a side of said storage tank above a bottom of said storage tank; and removing residue from above said bottom of said storage tank. The present invention further describes a device for holding a bottom of a wall of a storage tank, and a system for a separable bottom and side of a storage tank.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may be understood by reference to the following detailed description when read with the accompanying drawings in which:

FIG. 1A is a schematic representation of an AST having installed a lifting system in accordance with an embodiment of the invention;

FIG. 1B is a schematic representation of an AST that has been lifted above its bottom in accordance with an embodiment of the invention;

FIG. 2 is a schematic representation of a trench to receive a wall of an AST in accordance with an embodiment of the invention;

FIG. 3 is a schematic representation of an AST lifting system in accordance with an embodiment of the invention, according to embodiments of the invention;

FIG. 4 is a schematic representation of a bottom and a side of an AST and a receptacle for such members; and

FIG. 5 is a flow diagram of a method in accordance with an embodiment of the invention.

### DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention. It is to be understood that the phraseology and terminology employed herein is for the purpose of description and should not be regarded as limiting.

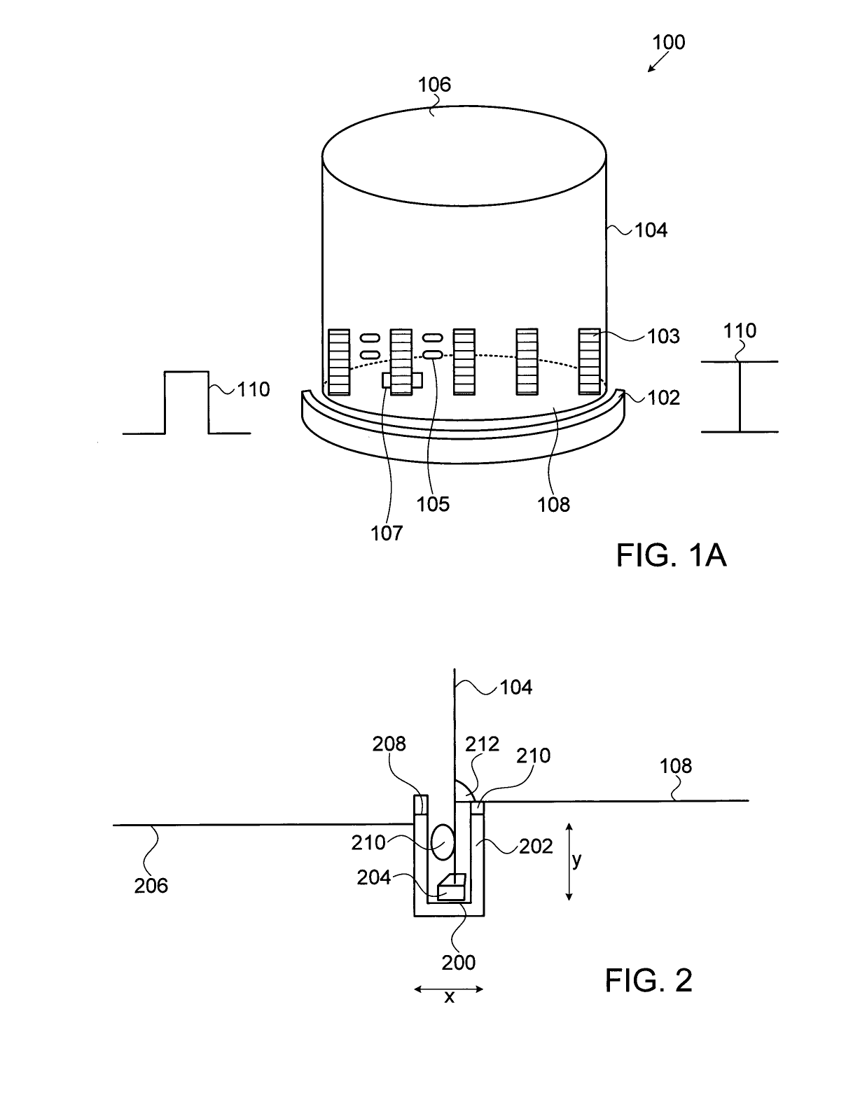

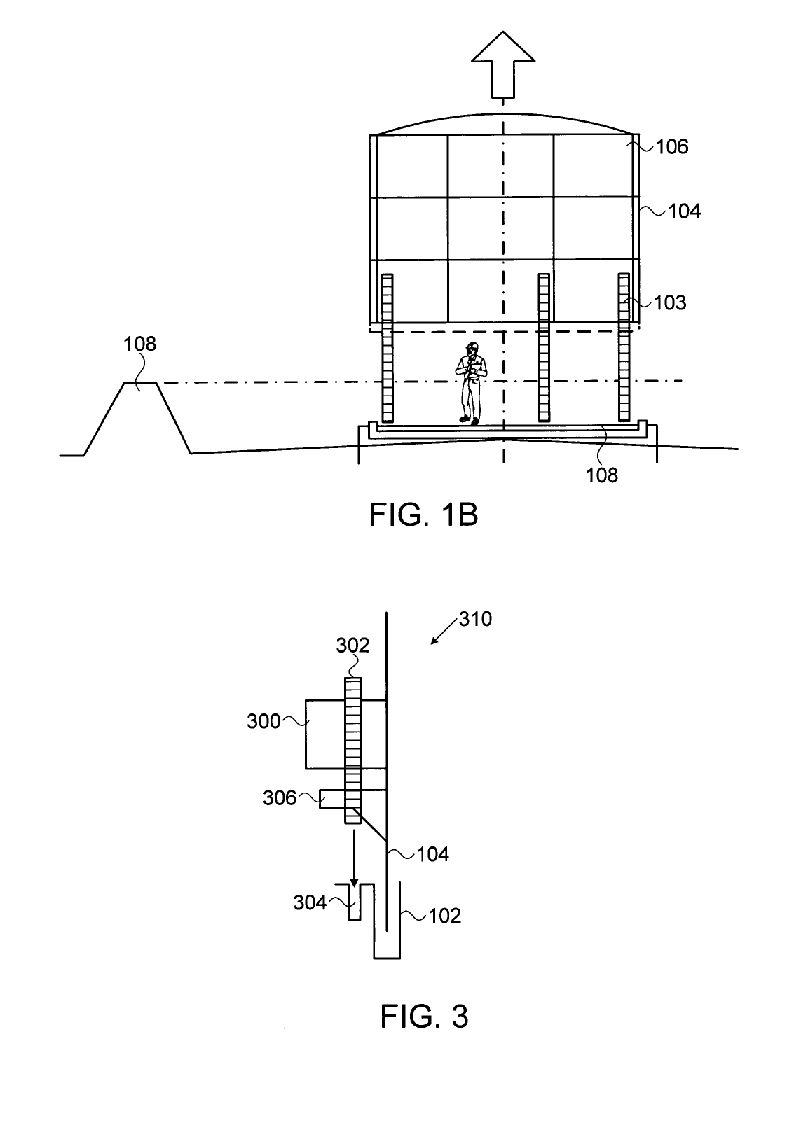

Reference is made to FIG. 1, a schematic representation of an AST having installed thereon a lifting system in accordance with an embodiment of the invention. In some embodiments, system 100 may include a receptacle that may take the shape of a trench 102 that may match the circumferential shape and dimensions of the outside wall 104 of an AST 106. For example, if a circular AST has a circumference of 12 meters and a diameter of 3.8 meters, trench 102 may similarly have a circumference of 12 meters and a diameter of 3.8 meters. Other shapes and dimension of trench 102 are possible. Dimensions of trench 102 may in some embodiments match a dimension of a perimeter of bottom 108 of tank 106 so that for example the open area of a top of trench 102 may be directly underneath an outside edge of bottom 108. Such fit of a top of trench 102 under an outer edge or perimeter of bottom 108 may be maintained around an entire circumference of bottom 108.

In some embodiments, wall 104 may have installed thereon or attached thereto one or more notched columns 103 or other devices that may receive a lifting force from for example one or more jacks 107 or other lifting devices that may connect to such notched columns 103 and convey a lifting force to wall 104. In some embodiments, screw-fitted or notched columns 103 may be removably fitted onto clasps 105 or connectors that are attached to wall 104, so that notched columns 103 may be detached from wall 104 when not in use.

A berm 110 or containment ditch may surround tank 106 to catch leakage or other materials that may escape from tank 106 when walls 104 are raised or at other times.

In operation, bottom 108 of tank 106 may be separated from wall 104 around some or all of a circumference of tank 106. Such separation may be accomplished by cutting, torching, or other means as may be appropriate for the material of which tank 106 is constructed. As appears in FIG. 1B, once bottom 108 has been separated from wall 104, wall 104 may be lifted. Such lifting may be accomplished by for example a series of jacks 107 or other providers of vertical force, as may be attached to notched columns 103 that may be fitted onto wall 104 by way of for example clasps 105. In some embodiments, the action of jacks 107 may be coordinated to provide an even lifting force around a circumference of wall 104, to ensure a smooth lift and to prevent buckling or rupture of wall 104.

In some embodiments, a separation of wall 104 from bottom 108 may be undertaken in stages beginning with a single location so that liquids that remain in tank 106 may seep out of such specific location and be collected conveniently, before the entire wall 104 is lifted. In some embodiments, liquids from tank 106 may be collected in berm 110 or channel that may be excavated around tank 106 to contain liquids that may seep out of the tank and store them for further processing. Once wall 104 has been lifted, sludge or other residues that may have accumulated on bottom 108 may be cleared and removed.

Reference is made to FIG. 2, a schematic representation of a trench to receive a wall of an AST in accordance with an embodiment of the invention. Such receptacle or trench 102 may have a depth ‘y’ of between 5 cm and 20 cm, though other depths are possible as may be required to accommodate soil or geological conditions in an area of the AST, to accommodate local regulations or for other reasons. A width ‘x’ of trench 102 may be up to 2 times wider than the thickness of wall 104, so that the greater width of trench 102 snugly accommodate wall 104 that is lowered into it. A base 200 and sides 202 of trench 102 may be constructed of for example reinforced concrete or other supporting structure as may be sufficient to support a weight of wall 104. Inner surfaces of trench 102 may be coated with epoxy or other leak proof sealant as may be appropriate to avoid seepage or leakage of a material contained in tank 106 from or through such base 200 or sides 202 of trench 102. In some embodiments a top of trench 102 may be slightly, partially or fully below grade 206 level of an area around tank, so that the ground or other supporting area around trench 102 may support sides 102. In some embodiments, an outer side 208 of trench 102 may be above grade 206, while an inner side 210 may be at grade 206 level so that the upper surface of inner side 210 is directly in contact with a bottom surface of bottom 108 of tank 106. Other configurations of sides 202 are possible.

In some embodiments, a first sealant 204 may be located or placed at a bottom of trench 102 and may extend along all or most of a length of trench 102. Wall 104 may be lowered or fitted into trench 102 on top of sealant 108 so that all or most of a bottom 200 of wall 104 rests on or in sealant 204, and so that a part of sealant 204 extends or bulges up from the bottom surface of wall 201 around one or both of an inside and an outside of wall 104 that rests inside trench 102. Sealant may be constructed of a gel or resin such as epoxy or other sealant as may be appropriate and sufficient to retain sealing properties upon exposure to a material stored in tank 106. In some embodiments, sealant 204 may be pressed or pumped into a bottom of trench 102. In some embodiments, sealant 204 may be contained in a tube or other outer coating that also has sealing properties. Preferable, sealant 204 may create a chemical and/or physical bond between bottom 200 and wall 104. Sealant 204 may preferable be constructed of a malleable material to assume a shape of a space and distance between a side of wall 104 and a side or bottom of trench 102.

In some embodiments, a flexible gasket or cover may, in addition to one or more sealants, be fitted onto one or more of a bottom surface of wall 104 and a side surface around a perimeter of bottom 108 to aid in forming a tight seal. The two gaskets may be connected upon the application of pressure or force of wall 104 against bottom 108. A gasket may also be inserted at bottom of trench 102 to connect with the gasket at the bottom of wall 104.

A sealant 210 may be pumped or pressed between an outer surface of wall 104 and side 108 to provide a further barrier against leaks of materials stored in tank 106. A third sealant 212 may be pressed at the joint or intersection point of bottom 108 and wall 104 and may extend over the inner side of the opening at the top of trench 102. In some embodiments, a width of third sealant may exceed a distance between wall 104 and bottom 108 so that sealant 212 connects and overlaps any space between wall 104 and bottom 108

In operation, one or more of separated wall 104 and bottom 108 may be smoothed, sanded or ground to create a smooth and straight surface around their respective circumferences. Bottom 108 may be centered within a perimeter of trench 102 as is described above, and wall 104 may be lowered into for example circular trench 102 and sealed by one or more of sealants 210, 212 and 204. The sealed points of contact of wall 104 with base 200, side 208 and bottom 108 may store and contain the materials that are stored in tank 106.

In advance of a next cleaning of sludge or residue in tank 106, the sealants may be broken or dissolved, liquid in the tank may be siphoned off, and walls 104 may be raised again. In some embodiments, bottom 108 may be lifted as part of a cleaning and emptying process to check for holes, leaks, corrosion or other problems.

Reference is made to FIG. 3, a schematic representation of an AST lifting system in accordance with an embodiment of the invention, according to embodiments of the invention. In some embodiments a lifting system 310 may include a jack 300, a screw-fitted or notched column 302, a base 306 and a base receptacle 304. Base 306 may moveably hold notched column 302 so that when column 302 is rotated by jack 300, column 302 is lowered into receptacle 304 and presses against a bottom of receptacle 304. The downward force of column 302 against receptacle 304 may raise wall 104. A series of lifting systems 310 may be placed at various intervals on a circumference of wall 104, and the jacks may be activated in coordination to supply uniform lift around the entire wall 104. Once lifted, wall 104 may be suspended temporarily on columns 302 or on alternative supports. Wall 104 may be lowered by for example reversing a direction of rotation of jack 300 and columns 302. Other methods of lifting and lowering walls 104 are possible.

In some embodiments, one or more of jack 300, base 306 and column 302 may be installed and removed from around a tank, so that a single lifting system kit can service numerous tanks.

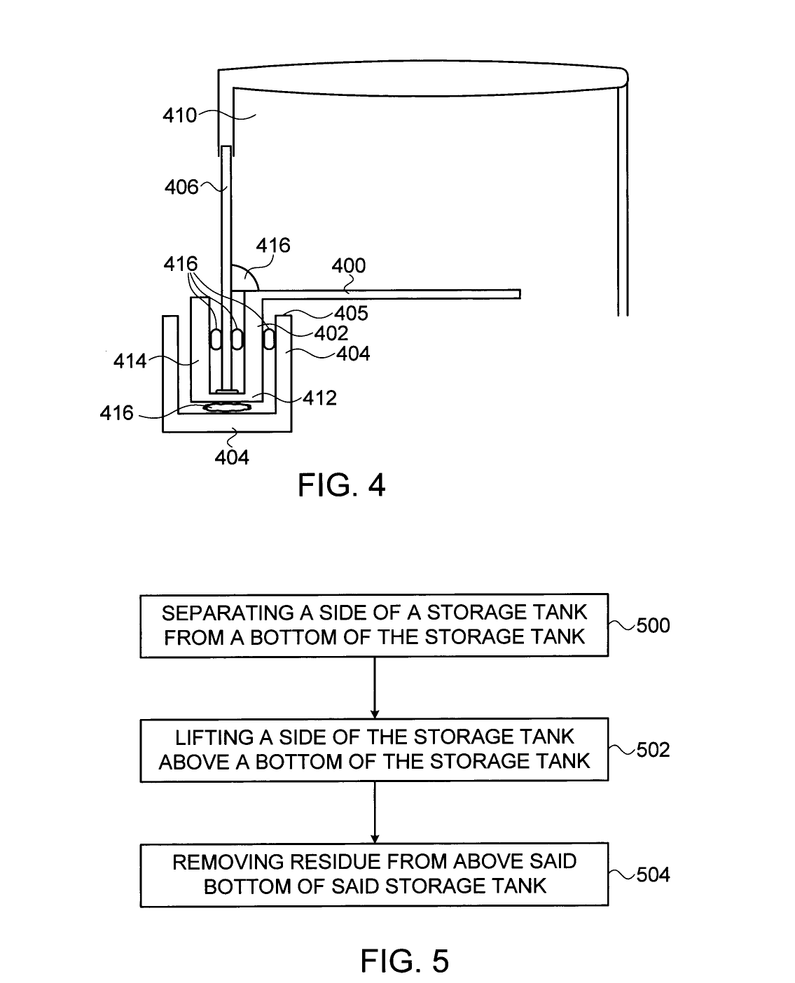

Reference is made to FIG. 4, a schematic representation of a bottom and a side of an AST and a receptacle for such members. In some embodiments, a horizontal bottom 400 of a tank may terminate in a vertical flange 402 that may be fitted into receptacle 404. In some embodiments, flange 402 may drop at for example a right angle or other angle from a side circumference of bottom 400, and a length of flange 402 may be less than a depth of receptacle 404 as measured from the top 405 ledge of an inside of receptacle 404 to the base of receptacle 404. Flange 402 may be fitted along an inside of receptacle 404, and wall 406 of tank 410 may be lowered toward outside of flange 402 but still within receptacle 404. In some embodiments, flange 402 may continue in a lateral or horizontal direction 412 and then again in a vertical direction 414 to form a U shaped or cup shaped construction, having either curved, partially curved or right angled sides, and which rests inside of receptacle 404. Wall 406 may rest inside and be supported by the U shaped construction of flange 402. One or more sealants 416 may be inserted, pumped or pressed into the contact points or spaces between one or more of wall 406, flange 402 and receptacle 404. One or more gaskets or flexible sealant extensions may be fitted into one or more of for example a bottom of wall 406, an inside of the U shaped construction or a bottom of the U shaped construction, to add to the seal created at the various points of contact of such structures.

Reference is made to FIG. 5, a flow diagram of a method for vacuating residue from an above ground storage of in accordance with an embodiment of the invention. In some embodiments, as shown in block 500, a method may include separating a side of a storage tank from a bottom of the storage tank. Such separating may include lifting the side wall such as a cylindrical side wall away from and above a bottom of the AST. In cases where the side and bottom walls are attached to create a single continuous unit of the tank, the side and bottom may be cut or sawed around for example a circumference of the bottom or base of the tank. In block 502, the side of the tank may be lifted above the bottom, and in block 504, residue or sludge may be removed from the bottom of the tank in the space between the lifted side and the bottom. In some embodiments, the lifting may include jacking up all of the circumferential side walls of the tank in coordination so that all sides are raised to the same height at the same time. In some embodiments, one or more members such as support members may be attached to one or more areas around a circumference of the side walls of the tank, and a lifting system may exert a lifting force on one or more of such members.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for vacuating residue from an above ground storage comprising:
separating a side of said storage tank from a bottom of said storage tank;
lifting a side of said storage tank above a bottom of said storage tank; and
removing residue from above said bottom of said storage tank.

2. The method as in claim 1, wherein said separating comprises separating a cylindrically shaped side structure of said storage tank from said bottom of said storage tank.

3. The method as in claim 1, wherein said lifting comprises lifting the circumferential side wall of said storage tank.

4. The method as in claim 1, wherein said lifting comprises jacking up said side wall of said storage tank.

5. The method as in claim 1, comprising attaching to said side a plurality of members, one of said members suitable to engage a lifting jack.

6. The method as in claim 1, comprising excavating a channel from a perimeter of said tank to contain said residue.

7. A device for holding a bottom of a wall of a storage tank, comprising:
a vertical receptacle, said receptacle having a width greater than a width of said wall, and having circumferential dimensions matching a circumferential dimension of said wall; and
a sealant at a bottom of said receptacle, said first sealant to support said bottom of said wall and to extend above said bottom of said wall along both an inside of said wall and an outside of said wall.

8. The device as in claim 7, comprising a second sealant between a side of said receptacle and a side of said wall, said second sealant having a malleable shape property to assume a distance between an outside of said wall and a side of said receptacle.

9. The device as in claim 7, comprising a third sealant, said third sealant having a width at a lower section thereof equal to a distance between an inside of said wall and a top of an inside of said receptacle, and having a lip at an upper section thereof extending over said top of said inside of said receptacle.

10. The device as in claim 7, wherein said receptacle is below a surface of a bottom of said tank.

11. A system for a separable bottom and side of a storage tank, comprising:
a side member of said tank;
a bottom member of said tank, said bottom member comprising a separable construction from said side member;
a vertical receptacle for receiving said side member;
a first sealant to seal said side member in said receptacle; and
a second sealant to seal said bottom member to at least one of said receptacle and said side member.

12. The system as in claim 11, wherein a bottom of said receptacle is below a grade of said bottom member.

13. The system as in claim 11, wherein said bottom member includes a vertical flange around a perimeter of said bottom member; and wherein said receptacle is for receiving said flange.

14. The system as in claim 13, wherein said second sealant is to seal said side member to said flange.

15. The system as in claim 12, wherein said bottom member includes a horizontal flange around a perimeter of said vertical flange, said horizontal flange extending outwards from said perimeter of said bottom member, said horizontal flange suitable to fit inside said receptacle and suitable to receive said side member inside said receptacle.
